(19) United States
(12) Patent Application Publication
(10) Pub. No.: US 2025/0200519 A1
(43) Pub. Date: Jun. 19, 2025

(54) MULTIPLAYER TIMELINE

(71) Applicant: Sequence Arts & Technologies, Inc., Long Beach, CA (US)

(72) Inventor: Lucas Alexander McGartland, Long Beach, CA (US)

(73) Assignee: Sequence Arts & Technologies, Inc., Long Beach, CA (US)

(21) Appl. No.: 18/981,244

(22) Filed: Dec. 13, 2024

Related U.S. Application Data
(60) Provisional application No. 63/610,872, filed on Dec. 15, 2023.

(51) Int. Cl. G06Q 10/10; G11B 27/036; G11B 27/34

(52) U.S. Cl. CPC G06Q 10/103; G11B 27/036; G11B 27/34

(57) ABSTRACT

A method and system provide for conflict-free collaborative temporal based media asset editing. Stored project data includes operations that are mutations of a common project state and an execution order. The common project state defines clips and timelines. Each clip is a temporal region of the asset and each timeline is a temporal and mixing order of the clips. The temporal and mixing order is defined referentially where a location of each clip is defined relatively with respect to a remaining clip. A collaborative environment between participants is established where new operations from other participants are transmitted to other participants in real time. Stored project data is updated with the new operations. The clips are placed based on the temporal and mixing order such that two clips cannot be placed in a same location on a single timeline.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/610,872, filed on Dec. 15, 2023, with inventor(s) Lucas Alexander McGartland, entitled “Multiplayer Timeline,” attorneys' docket number 297.0001USP1.

### BACKGROUND OF THE INVENTION

### 1. Field of the Invention.

The present invention relates generally to media asset editing, and in particular, to a method, apparatus, system, and article of manufacture for conflict free collaborative temporal based media asset editing.

### 2. Description of the Related Art.

A non-linear editor (NLE) is an application that allows a user to compose a sequence of audio and video segments (referred to as clips), traditionally in a timeline. Prior art systems fail to provide the ability to collaborate fully in a single timeline without overly restrictive limitations. To better understand the problems of the prior art, a more detailed description of basic NLE timeline concepts and prior art problems may be useful.

### Non-Linear Timeline Concepts

As described above, NLE applications allow users to compose a sequence of audio and video segments, traditionally in a timeline. These segments, commonly known as “clips,” describe a section of an audio/video asset, and where the segment belongs in the timeline. For example, Clip A takes a second of video and audio from a 30 second MP4 file, starting at 10 seconds, and it is placed at the 5 second point in the timeline.

One may think editing an audio/video timeline is like a text document, where you copy parts out of one document and insert it into a new document. However, an NLE timeline is different. The clips are references to other files; they are not copies of the contents of those files.

An NLE timeline may be thought of as a two-dimensional matrix that uses one axis to represent the temporal ordering of the clips, while the other axis represents the audio/video mixing of the clips. The mixing axis is often broken down into units that are typically described as tracks or lanes.

For video clips, the mixing order controls how the imagery is layered and blended. For audio clips, the mixing ordering controls how sound is both mixed together and channelized for playback on multiple speakers.

To summarize:
A clip is a reference to a temporal segment of an audio/video file;
A clip has both a temporal and mixing order; and
Two clips cannot exist at the same point in time, in the same mixing order.

As stated above, prior art NLE applications fail to provide the ability to collaborate fully in a single timeline without enforcing overly restrictive media asset controls. For example, prior art systems rely on media asset locking where no modifications are permitted within a certain range on an object/asset within a timeline (or on a bin basis) or across multiple timelines in a shared project. In this regard, NLEs that allow real-time collaboration on a given project usually place limits on the level of collaboration because conflict resolution can be difficult. Conflicts can lead to project corruption and lost work. To avoid conflicts, typically, prior art editing applications supporting multiple users do so by implementing some form of “locking” to prevent other users from editing, limiting those users to a view-only role. In other words, prior art systems fail to provide full collaboration in real time without any resource constraints.

FIG. 1A illustrates a timeline with clips of the prior art. As illustrated, clips 102A-102E (collectively referred to as clips 102) and 112A-112E (collectively referred to as clips 112) in the prior art are given a unique combination of horizontal and vertical positions in a timeline. With a traditional NLE timeline, a clip's 102/112 horizontal position is described with an absolute temporal coordinate, also known as a timecode. Its vertical position is a lane 104-110 or track, but it can be any lane/track, given that it does not collide with another clip 102/112. So, in a traditional NLE timeline there can be gaps 114/116 between clips 102/112, both vertically and horizontally. These gaps 114/116 typically become moments of blackness or transparency for video and silence for audio. Thus, prior art systems fail to provide a timeline that does not have residual unwanted side effects (e.g., blackness or silence).

In view of the above, what is needed is a conflict free collaborative temporal based media asset editing system that avoids/minimizes unwanted residual side effects.

### SUMMARY OF THE INVENTION

Embodiments of the invention provide a multiplayer reflow timeline that enables various novel techniques. Specifically, embodiments of the invention allow conflict free editing of video and audio reflow timelines across multiple users in real time. Further, embodiments of the invention show in-progress and conflict-free operations of rearranging clips in a timeline across all users. In addition, embodiments maintain a user's viewport of the timeline even as upstream changes are made to the timeline that would normally shift the contents of their view. Also, embodiments provide the ability to revert to a project state at any granular point in its history.

### BRIEF DESCRIPTION OF THE DRAWINGS

Referring now to the drawings in which like reference numbers represent corresponding parts throughout:

FIG. 1A illustrates a timeline with clips of the prior art;

FIG. 1B illustrates the selection of a clip that automatically selects associated clips in accordance with one or more embodiments of the invention;

FIG. 1C illustrates the display of a ghost clip visible behind a clip being moved down a timeline in accordance with one or more embodiments of the invention;

FIG. 1D illustrates a timeline reflow with shifting clips in accordance with one or more embodiments of the invention;

FIG. 1E illustrates a final version of a clip where relative offsets of linked clips are maintained in accordance with one or more embodiments of the invention;

FIG. 2 illustrates an OpSet and a shared state structure in accordance with one or more embodiments of the invention;

FIG. 3 illustrates the OpSet and state structure subsequent to element movement in the primary storyline in accordance with one or more embodiments of the invention;

FIG. 4 illustrates further references to prior and next in accordance with one or more embodiments of the invention;

FIG. 5 illustrates the state and layout of a fully realized timeline in accordance with one or more embodiments of the invention;

FIG. 6 illustrates an updated state and layout of a fully realized timeline with a new element inserted in between elements in FIG. 5 in accordance with one or more embodiments of the invention;

FIG. 7 illustrates the state to horizontal and vertical layout in accordance with one or more embodiments of the invention;

FIG. 8 illustrates a system diagram for implementing one or more embodiments of the invention;

FIG. 9 illustrates the logical flow for conflict-free collaborative temporal based media asset editing in accordance with one or more embodiments of the invention;

FIG. 10 is an exemplary hardware and software environment used to implement one or more embodiments of the invention; and

FIG. 11 schematically illustrates a typical distributed/cloud-based computer system in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention overcome the problems of the prior art by providing a multiplayer reflow timeline. The multiplayer reflow timeline:
Allows conflict free editing of video and audio reflow timelines across multiple users in real time.
Shows in-progress and conflict-free operations of rearranging clips in a timeline across all users. In-flight positions are shown as a user makes changes and affects other user's layouts. Such capabilities gives all the players context of what changes are being made. In contrast, in prior art systems—clips spawn in and out of existence but actual changes by other users are NOT shown.
Maintains a user's viewport of the timeline even as upstream changes are made to the timeline that would normally shift the contents of their view. In this regard, all users' changes are updated in real time across all users viewports. In the prior art, if user 1 adds text above user 2, it would normally push user 2 down and that can be disruptive. Embodiments of the invention provide a viewport such that if upstream changes affect another user's work/view, the viewport remains locked so it doesn't disrupt the other user's workflow. In addition, while timestamps may be shown, the viewport remains. Further, absolute and relative positions of clips are maintained.
Provides the ability to revert to a project state at any granular point in its history. In this regard, embodiments of the invention enable the selection of a logical time stamp along a set of operations and the user can revert to that point in time. Further, a slider may be provided such that while the slider is dragged, the user can watch/view the media assets/clips/etc. being edited. In addition, projects of embodiments of the invention are non-destructive and incrementally build on the prior state.

### Reflow vs Traditional Timelines in Non-Linear Editors

As described above, the prior art fails to provide the ability to collaborate fully in a single timeline without relying on restricted resource access. Embodiments of the invention enable full collaboration in real time without any resource constraints.

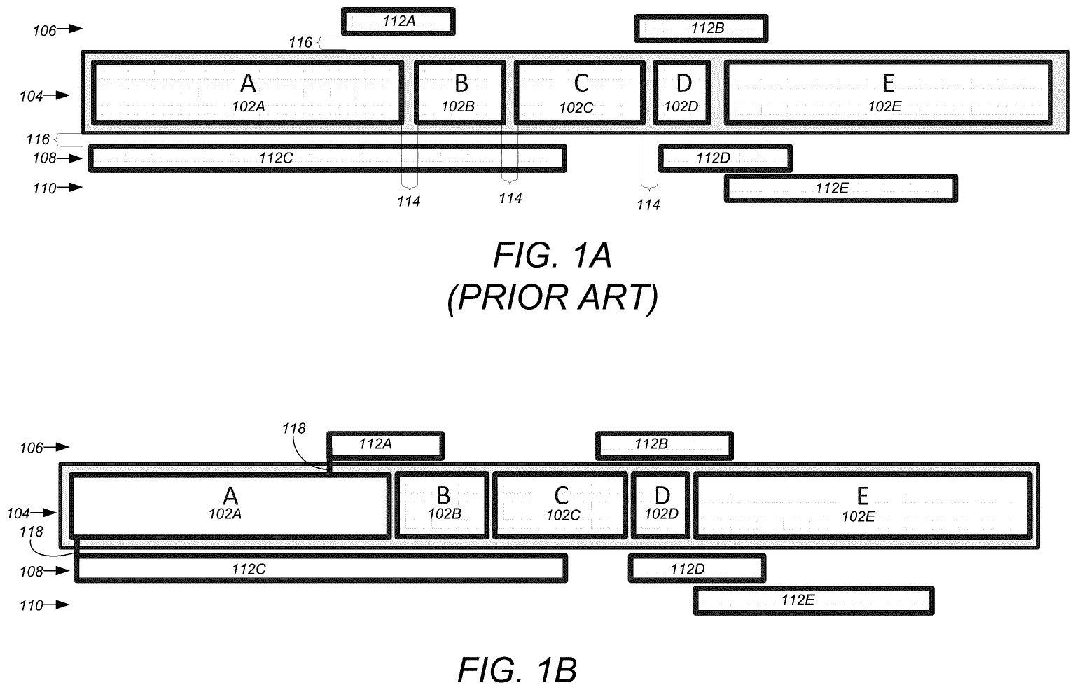

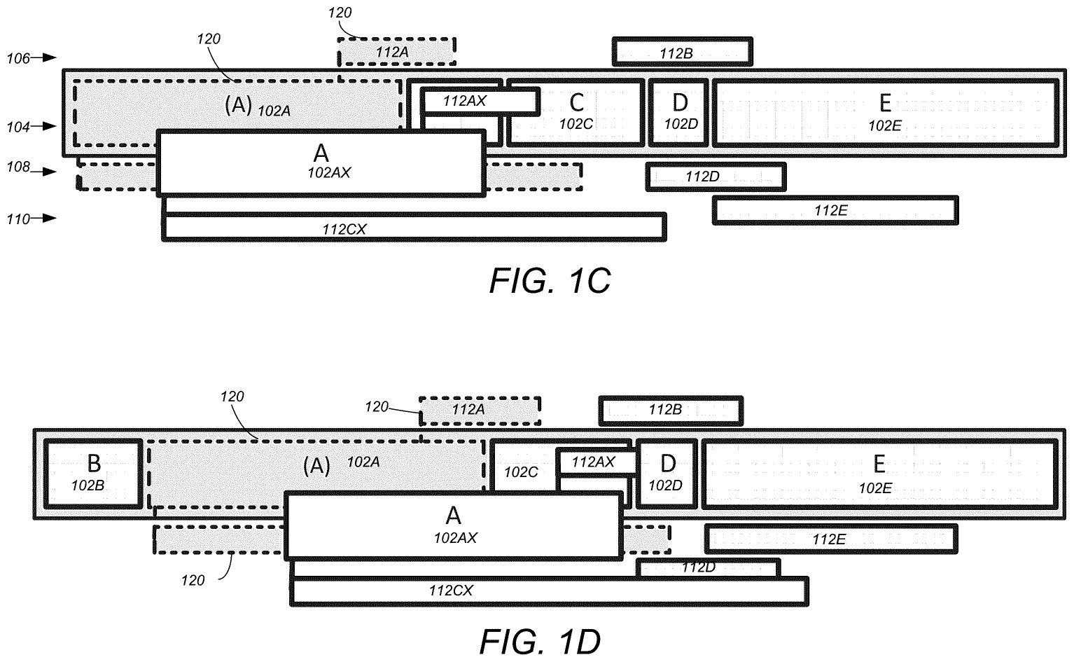

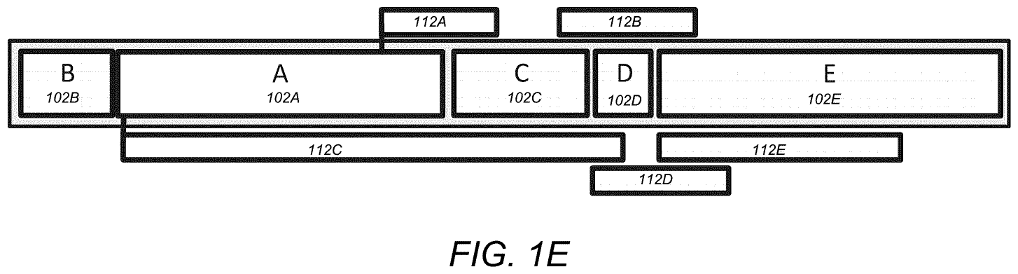

Referring again to FIG. 1A, with traditional NLE timelines, there can be gaps 114/116 between clips 102/112 both vertically and horizontally. Such gaps 114/116 typically become moments of blackness or transparency for video and silence for audio.

With a reflow timeline of embodiments of the invention, gaps 114/116 are not allowed. Every clip 102/112, but the first, is positioned relative to another clip 102/112, either to the right, above or below another. Referring to FIG. 1A, embodiments provide a Primary Storyline 104, which is the main lane of composition. Any clip 112 in a lane above 106 or below 108/110 a clip 102 in the primary storyline 104 becomes attached to the primary storyline 104 clip. As that primary clip 104 moves temporally, its attached clips move along with it. When the parent clip is repositioned, its neighboring clips on the storyline will exchange places, or reflow, ensuring there are no gaps.

Referring again to FIG. 1A, a timeline is comprised of clips 102A-102E (labeled A-E) of media laid out sequentially in the “Primary Storyline” 104, flanked with lanes 106-110 of “Attached Clips” 112 above (i.e., clips 112A-112B) and below (i.e., clips 112C-112E) the storyline 104.

In a reflow timeline, if blackness or silence is required by the story, a special “placeholder” clip can be inserted by the user.

FIG. 1B illustrates the selection of the “Primary A” clip 102A where such a clip selection automatically/autonomously selects attached clips in accordance with one or more embodiments of the invention. In this regard, note the clips above 112A and below 112C Primary A 102A are implicitly linked to Primary A clip 102A (indicated by lines 118).

FIG. 1C illustrates that as the clip is moved down the timeline (indicated by 102AX, 112AX, and 112CX), a ghost (indicated by dashed lines 120) is visible behind the clip 120AX, 112AX, 112CX, which is an indicator of where the clip would land if it were released. As indicated in FIG. 1C, as the primary clip 120AX moves temporally, its attached clips (i.e., clips 112AX and 112CX) move along with it.

FIG. 1D illustrates that as the clip 102AX is moved down the timeline, past the next clip 120B, the timeline reflows, shifting the second clip 102B to the left, towards the start, and a space is made for the initial clip 102A along with a ghost indicator (dashed line 120) showing where it would be dropped when released. It may also be noted that the linked clips 112AX and 112CX moved along with the initial clip remaining above it (i.e., in the ghost 120 as well as in the clip 102AX being moved).

Lastly, in FIG. 1E, the initial clip 102A is finally released. As illustrated, the associated linked clip above 112A and linked clip below 11C has the same relative offset as its original location (i.e., in FIG. 1A/1B) (while clip 112D is attached to clip 102D and clip 112E is attached to clip 102E).

In view of the above, it may be seen that traditional prior art timelines place a clip in a specified lane at an absolute time while allowing/permitting gaps between clips, both in time/horizontally, and mixing/vertically. In contrast, the reflow timeline of embodiments of the invention places each clip relative to another (except the first clip, which is placed at the origin of the Primary Storyline Lane 104). While both the prior art and embodiments of the invention follow the common rule that every clip must have a unique, non-overlapping horizontal/vertical position combination, a reflow timeline's data model guarantees it.

Further to the above, it may be seen that while clips are being moved, if over a valid layout, the clip is stored at that timeline location. Accordingly, if the user loses internet connection, for example, the clip will still be at that location (the timeline placement location is stored). In other words, the ghost position (indicated by dashed lines of clips 102A and 112A) is the real stored position, and the floating position (e.g., indicated by a mouse cursor and or the solid lines around clips 102AX and 112CX) are for display purposes.

### Collaboration in a Common Timeline

As described above, NLEs that allow real-time collaboration on a given project usually place limits on the level of collaboration because conflict resolution can be difficult. Conflicts can lead to project corruption and lost work. To avoid conflicts, typically, prior art editing applications supporting multiple users do so by implementing some form of “locking” to prevent other users from editing, limiting those users to a view-only role.

Embodiments of the invention provide a true multiplayer application. Every user has the potential to make any edit to any timeline at any time, without worry of corruption caused by conflicts. This is due to the use of CRDTs, or Conflict-Free Replicated Data Types, to define the project structure. Specifically, embodiments of the invention use a data type, called an OpSet, which is comprised of relatively simple structures that describe an Operation that mutates the project state.

Operations include, but are not limited to:
Adding a Clip to the timeline;
Trimming a Clip;
Deleting a Clip;
Dissecting a Clip;
Moving a Clip's position to the right, above or below another Clip in the timeline;
Modifying a Clip's mixing, compositing, color properties; and
Modifying the dimensions and framerate of the timeline.

Every incremental change any user makes to the timeline is described by one or more of these operations, stored in a globally ordered and synchronized OpSet. This makes a project of embodiments of the invention non-destructive.

Every Operation can be deterministically ordered in the set according to a logical clock timestamp. This timestamp is used to ensure operations are stored and processed in a guaranteed order.

Every client may work on its own copy of the OpSet, but any change made to the client's copy is sent to a central authority, the Multiplayer Service. The Multiplayer Service is responsible for synchronizing changes across all clients, sending any change to the OpSet from one client to all other active clients. It is also responsible for ensuring the clients local copy of the logical clock is up to date. In theory, the collaborative timeline of embodiments of the invention could operate in a purely peer-to-peer mode, but the centralized Multiplayer service acts as a repository that acts as the final source of truth for project timeline data.

As a client receives new operations from other clients, it sorts them into its existing OpSet, using the operation's logical clock timestamp, and then executes the newly modified OpSet. Once a client receives all the operations from all other clients, the resulting executed state will become consistent.

Since operations are referential, the execution of any operation may consider how to best leverage those references. One novelty in embodiments of the invention is how operations are executed—where every operation is atomic and the functions that implement each operation know how to resolve potential conflicts specific to the objects referenced by the operation. Operations of embodiments of the invention are structured to best handle the conflicts that could arise in multiplayer timeline editing.

For example, if one user moves a clip that another user is about to dissect, when the move is completed, the result should be a newly dissected clip in its new position.

Another example is ensuring that clips remain ordered as the user intended. One existing approach to collaboratively ordering items in a list involved the use of fractional indexing, where each item in a list was given an index between 0 and 1 (e.g. 0.1, 0.2, 0.5). To insert an item between index 0.1 and 0.2, the new index would be 0.15. This approach leads to problems of interleaving items when multiple items are rearranged to the same index at the same time, which would be heavily destructive from the perspective of editing. Embodiments of the invention use operations that place elements relative to others, preserving the editor's intent when rearranging the timeline.

Since the state of the project is determined by the set of operations included, it is possible to pick a logical timestamp and execute the operations up until that point to arrive at a prior version of the state. This allows a user to “time-travel” and revisit any prior point in the project history, and from there, revert, fork or even include new changes by splicing in operations. An additional form of version control could be introduced by having branches of operations that are not merged into the main set, unless approved by an administrator, allowing for branches of a project to be worked on in parallel.

### Shared State

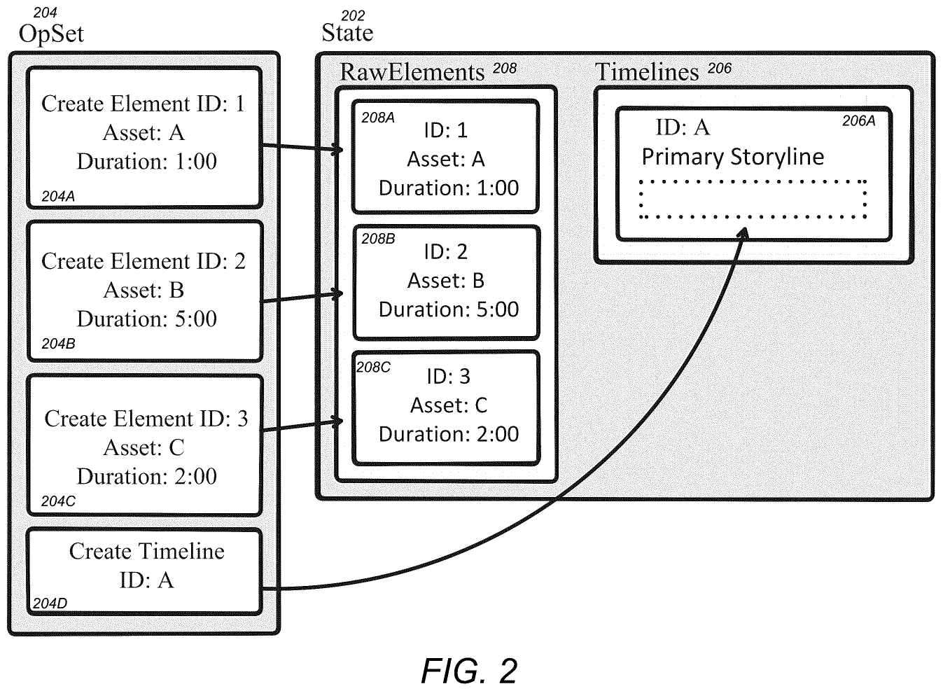

FIG. 2 illustrates an OpSet and a shared state structure in accordance with one or more embodiments of the invention. At the heart of the project is the shared state structure 202 (also referred to as shared state 202). State 202 is the accumulated structures which are the summation of the operations (i.e., OpSet 204) described above. State 202 contains the structured information about timelines 206, clips 206A used within those timelines 206, effects, and property objects applied to those. State 202 may hold onto these structures, even if they are no longer used by any timeline 206, currently.

### RawElements Use in State

Each RawElement 208A-208C contains information about the clip, irrespective of its temporal position in the timeline 206. When manipulating a clip, an operation 204A-204D (e.g., Create Element operations 204-204C and Create Timeline operation 204D) acts on the RawElements 208A-208C and timeline 206C respectively.

The RawElements 208 contains a set of RawElements (208A-208C) with each RawElement 208A-208C identifiable via a reference ID (e.g., ID: 1, ID: 2, and ID: 3). The RawElements 208 also contains a reference to the segment of media to be played at the clip's position (i.e., Asset: A, Asset: B, and Asset: C) (along with the duration of each clip—i.e., Duration: 1:00, Duration: 5:00, and Duration: 2:00), and a set of references (ID: 1, ID: 2, and ID: 3) of other RawElements 208A-208C that are attached above or below itself if the element is used in the primary storyline 206A. Further, the RawElement 208A-208C contains other information that is useful for things like compositing and mixing. Each RawElement 208A-208C also has a flag that marks the Element as having been deleted from the Timeline (not shown in FIG. 2).

Some state structures once created, remain in the state 202, even when they are no longer being used by a timeline 206 or other structure, to prevent additional mutations to it post-deletion from failing or to allow recovery. Eventually, to clean up unused data, a process of removing these tombstoned (marked as deleted) pieces of state 202 can be garbage collected and entirely removed. This process is referred to as garbage collecting no longer used pieces of project state.

Further to the above, the RawElements 208 may also contain special “In-Flight” information that allows other users to observe clips being dragged around within the timeline 206, live (see further description below).

### Moving Elements in the Primary Storyline in the Timeline Using Operations

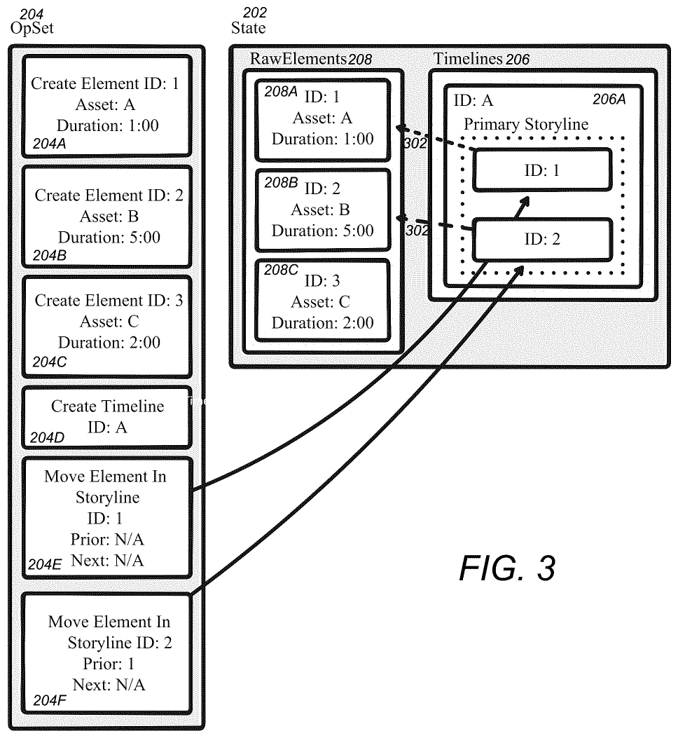

FIG. 3 illustrates the OpSet and state structure subsequent to element insertion in the primary storyline in accordance with one or more embodiments of the invention.

The Timeline object 206A contains sets of references (indicated by dashed arrows 302) to the RawElements (208A-208C) that comprise the story. These sets are sorted based on the relative reference specified in an operation 204A-204F. For example, the operation structure which performs “Move an Element After an Element” 204F specifies a reference (i.e., Prior: 1) to the RawElement 208A to move after. When executing this operation 204F, the system uses the reference (ID: 1) to find element of the set to move after, and then inserts the specified element after that element.

The operations 204A-204G may have additional parameters which include references to the element to move ahead/behind of (i.e., Prior/Next in 204E, 204F, and 204G). In other words, the op itself may specify the relative position of the clip to be inserted using the “Prior” and “Next” parameters. For example, when a new clip is added to the start of a new storyline 206A, there is no “Prior” or “Next” parameter. When a new clip is inserted to the start of an existing storyline 206A, there is no “Prior” parameter, the “Next” parameter will point to the clip that used to be at the start. When a new clip is inserted at the end of a storyline 206A, there is no “Next” parameter, and the “Prior” parameter points to the clip that was previously in the last position. When a new clip is inserted in between two clips, the “Prior” and “Next” parameters specify the relative position based on the clip before and after the location in which the new clip is to be inserted. When a clip is deleted, a delete operation (not illustrated) specifies the ID of the clip to be removed (no “Prior”/“Next” parameters are specified).

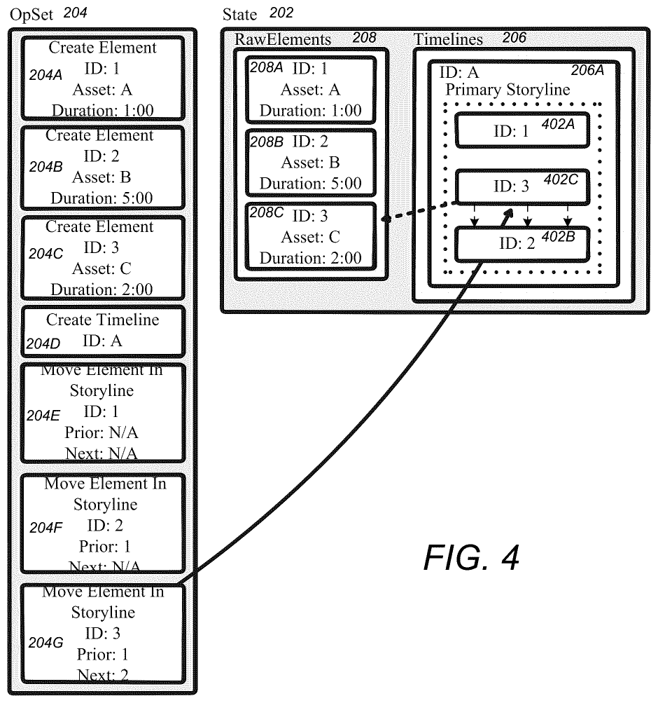

FIG. 4 illustrates further references to prior and next as indicated at 204G. A new clip, 402C, is added to the timeline between clips 402A and 402B, via a new operation 204G. The clip (i.e., clip ID 3 208C) was first created in the project state in prior operation 204C. The system, when executing operation 204G, uses the Prior reference first, when slotting the clip 208C into the set (i.e,, the system knows that clip ID 1 402A is the clip immediately prior to the new clip ID 3 402C being inserted). In other words, if the system is able to find the prior reference in the storyline 206A (i.e., ID 1 402A), the new clip 208C is slotted after that.

To avoid a conflict when the prior clip has been deleted by another user (i.e., the “Prior” parameter points to a clip that is no longer in the storyline 206A), the “Next” parameter will be used. In other words, the operation 204G would first attempt to place the clip based on the Prior parameter, and if unable to do so, proceeds to place the clip based on the Next parameter. For example, op 204G specifies the Next parameters (ID 2 402B), and the clip (e.g., clip 402C) is inserted ahead of that clip (ID 2 402B) in the storyline 206A.

### Transforming the Project State Into a Timeline Layout

Creating a conflict free data structure is only the first step in the collaborative reflow timeline editing of embodiments of the invention. The project state itself is not necessarily in a format that is usable for representation to the user due to structuring it for conflict resolution. An additional step of enrichment is done to process the state into a timeline layout that is digestible by a user using a layout engine. The following provides a description of the layout and graphical user interface.

### The LayoutElement

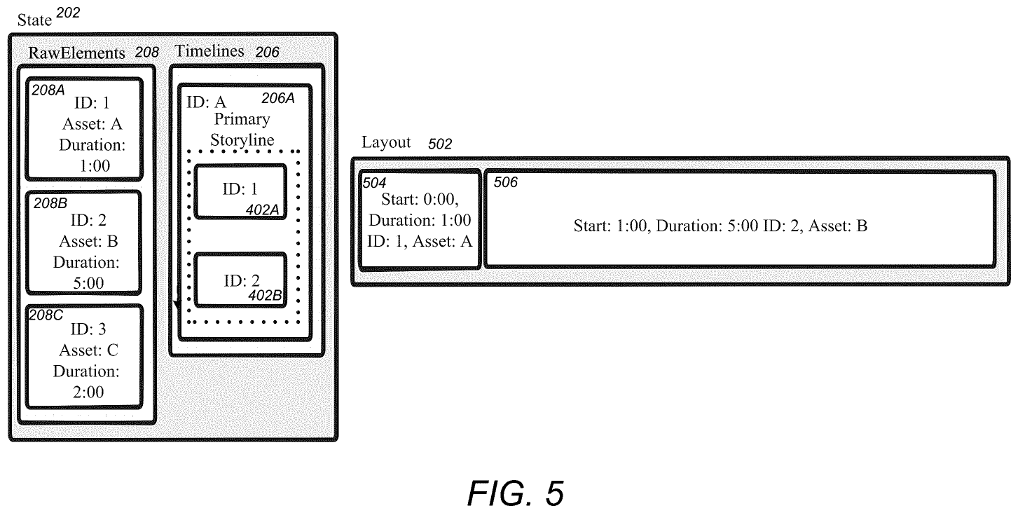

FIG. 5 illustrates the state and layout of a fully realized timeline in accordance with one or more embodiments of the invention. The LayoutElement 502 is a more concrete form of an element, after it has been temporally positioned in the timeline 206 by the Layout Engine. The Layout Engine is a series of routines that constructs a set of LayoutElements 502 given a set of RawElements 208, a Timeline 206, and other pieces of the project state. The Layout Engine slots these elements into horizontal temporal lanes, and vertical mixing layers, creating the fully realized timeline.

As the Layout Engine slots elements into a lane, it assigns a starting temporal position and duration (e.g., element 504 has a start of 0:00 and duration of 1:00; element 506 has a start of 1:00 (i.e., immediately subsequent to the duration of element 504) and a duration of 5:00). No two elements 504-506 can overlap in the same temporal position.

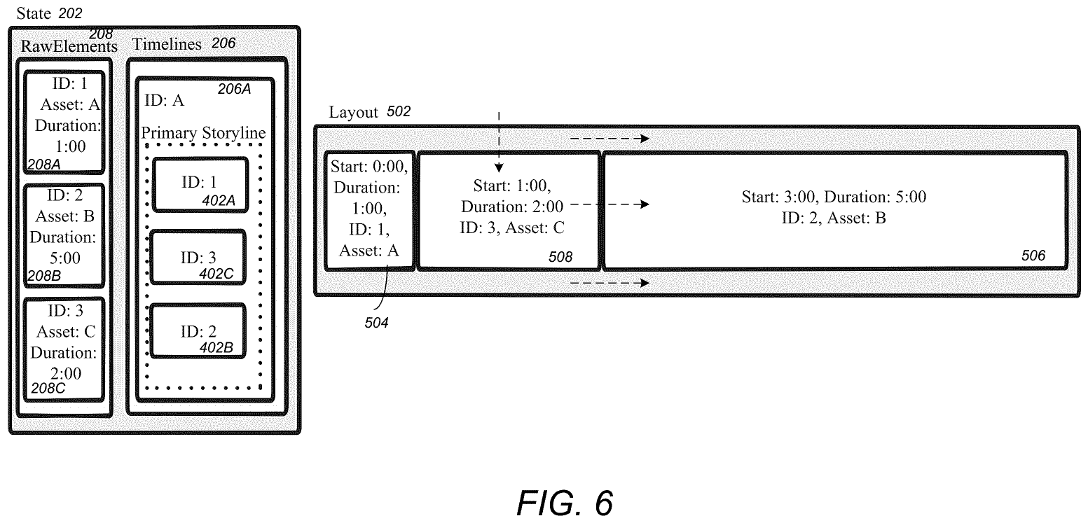

The Layout Engine knows how to push out of the way “later” LayoutElements 504-506 within the lane to make space to insert the new element. When reordering elements in this manner, the Layout Engine assigns new starting positions, referring to the prior element's duration. FIG. 6 illustrates an updated state and layout of a fully realized timeline with a new element inserted in between elements in FIG. 5 in accordance with one or more embodiments of the invention. As illustrated, clip 508 was inserted in between clips 504 and 506. The Layout Engine pushed layout element 506 over and assigned a new starting position (i.e., of 3:00) based on the duration of 2:00 of layout element 508 that was inserted in after element 504 and before element 506.

The vertical layers represent the mixing order of a set of elements that all share the same temporal region. The mixing order is especially important for image data, as clips in higher layer order are rendered on top of images of lower order. The Layout Engine intelligently stacks the LayoutElements based on data in the project state.

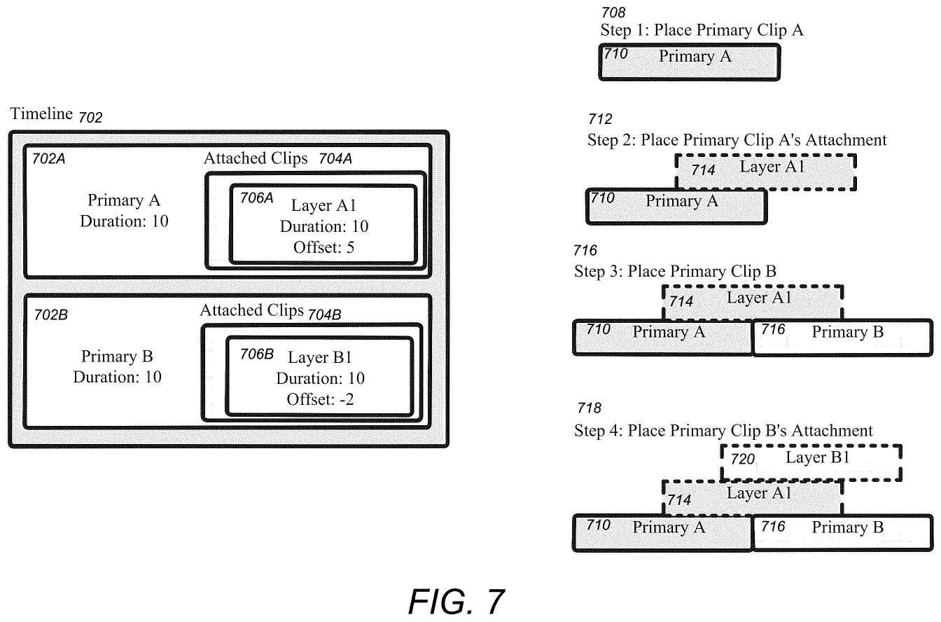

FIG. 7 illustrates the state to horizontal and vertical layout in accordance with one or more embodiments of the invention. In this regard, the common project state may be converted from its conflict-free relational model to an absolute layout model. As illustrated on the timeline 702, the common project state is a raw data model based on ordered sets: Primary B 702B comes after primary A 702A (and additional clips may proceed accordingly [e.g., C is over B 702B]).

Layout engine converts these clips 702A and 702B, laying them out into timeline 702, going left to right, bottom to top. The layout for the Primary Storyline places one clip directly after its predecessor. Attached clips are layered on top of its Primary, given an offset. If there is an attached clip in the same temporal position in that layer, the attached clip will be promoted to a higher layer (e.g., imagine stacking ala the Tetris game). This layout is used: (i) as the visual model the user interacts with; and (ii) to derive the render order for playback and export.

As illustrated at step 1 708, the Layout Engine places Primary Clip A (illustrated at 710). In step 2 712, the Layout Engine places primary clip A′s attachment in layer A1 714 (i.e., above primary A 710). In step 3 716, the Layout Engine places Primary Clip B 716 after Primary Clip A 710. Lastly, at step 718, the Layout Engine places Primary Clip B's attachment 720 in a new layer, above attachment 714. In this regard, the Layout Engine lays out the clips into the timeline going left to right bottom to top (with the clip attachments 714 and 720 located in lanes vertically above the primary clips 710 and 716).

### In-Flight Layout

One other feature of a system of embodiments of the invention is allowing complex interactions that involve a user feedback loop to be represented accurately across all users, in real-time. For example, dragging a clip from one position and dropping into another. This process uses the same set of operations and follows the same workflow through the Layout Engine resulting in new LayoutElements.

Without this feature, as clips are repositioned in a timeline, collaborating users would see clips hop along the timeline as the primary user drags the clip. By including additional in-flight metadata that describes a virtual screen position of the user interaction, the system allows the application to illustrate, in full fidelity, the activity of any user—showing both the clip's prospective drop position, as well as its current drag position. FIGS. 1B-1D illustrate the inflight features with the ghost clips (illustrated by the dashed lines) showing the prospective drop position as the user is dragging a clip 102AX (and it attached clips 112AX and 112CX).

Embodiments of the invention utilize a unique approach of storing both the absolute position of the where the in-flight dragged clip is in the Layout as well as a relative position to its current LayoutElement position. This allows embodiments of the invention to keep the in-flight representation of the clips in view even as another user may shift the timeline layout because of their operations.

### Continual Synchronization Across Clients and Services

A multiplayer service could rely on a single central authority service, but this presents scalability problems. The central authority can be a bottleneck and a single point of failure.

Accordingly, in embodiments of the invention, every client may execute the OpSet in the exact same manner, resulting in the same final state. A client whose OpSet falls behind will ultimately catch up by requesting missing operations, and using the logical clock timestamp, the new operations will be sorted into the OpSet in the correct order, and then executed into RawElements and run through the Layout Engine.

Thus, to summarize:
Operations are executed in order of their logical clock timestamp which modify project state;
The timeline object in the state maintains sorted sets of RawElements but lacks precise timing information;
At a periodic interval, the Layout Engine executes, converting RawElements to LayoutElements, calculating timestamp offsets, slotting them into temporal lanes, and determines mix order, slotting them into visible and audio layers;
Using additional in-flight metadata, live user interaction in the timeline can be represented in full fidelity in real-time, across all users; and
A set of heuristics are used to maintain the same viewport of the timeline even as changes to the duration of the timeline are made upstream of the viewer.

### System Diagram

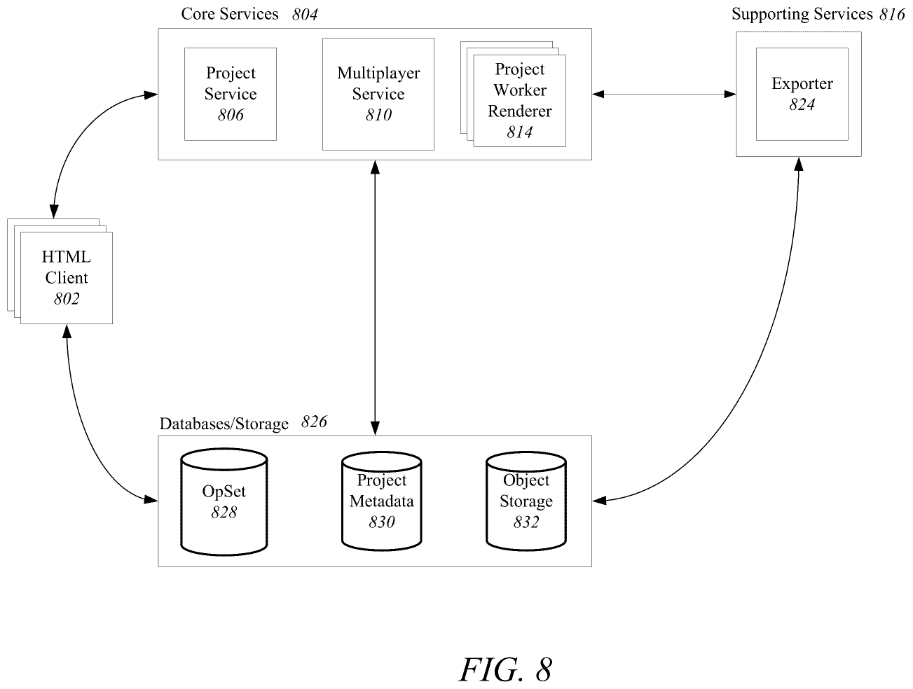

FIG. 8 illustrates a system diagram for implementing one or more embodiments of the invention. It may be noted that the layout engine described herein is a set of routines that is included in many services/applications. In this regard, the layout engine may be part of the client 802, core services 804 (e.g., multiplayer service 810 and the Project Worker Renderer 814) and supporting service 816 (e.g., the Exporter 824). Details regarding the applications/services follow.

### HTML Client 802

The HTML Client 802 is the desktop-like application running locally in a user's web browser that allows the user to manage projects, libraries, assets and edit timelines. As a user edits, OpSet updates are flushed from the client 802 and sent to the Multiplayer Service 810 to be synchronized with other participating clients 802. The client 802 also receives updates from other clients 802 in a similar manner, and the update includes the latest global logical clock timestamp.

### Core Services 804

Core services 804 include project service 806, multiplayer service 810, and project worker renderer 814. HTML Client 802 may communicate with and provide information to/from the different core services 804.

### Project Service 806

Project service 806 is the main service entry point for the client 802, providing a series of public and private APIs (application program interfaces). Project service 806 is responsible for maintaining all necessary service sessions. When the client 802 launches, the client 802 begins a new user session and queries the project service 806 for a connection to a Multiplayer Service 810—if one has not been started by any other user participating in the project, project service 806 will schedule a multiplayer service 810. Project service 806 is also responsible for scheduling a Project Worker Render 814 service for the new user session connecting to the project. When required by the user, project service 806 will schedule an exporter 824 session. The Project service 806 is responsible for scheduling the Multiplayer Service 810, Project Worker Renderer 814 and Exporter 824 services (e.g., via an open source system that automates the management, scaling, and deployment of containerized applications [e.g., the KUBERNETES system]).

### Multiplayer Service 810

Multiplayer service 810 is responsible for synchronizing OpSet updates among all participating HTML Clients 802 and their respective Project Worker Renderers 814. As new operations are received by the Multiplayer Service 810, it updates the global logical clock timestamp and distributes that back to the clients 802 when it synchronizes updates.

The Multiplayer Service 810 also writes the collected OpSet updates to a persistent database 828. At a periodic interval, multiplayer service 810 writes a serialized version of the summary Common Project State (i.e., to persistent database 828).

### Project Worker Renderer 814

The Project Worker Renderer service 814 is responsible for processing the OpSet, laying it out into a playable video stream, composed of the latest edits. There is an instance of this service 814 for every active HTML client 802. Off-loading rendering to a cloud compute service (such as the project worker renderer 814) gives desktop-level performance and capability where current web technologies will not suffice.

The rendered audio/video stream is transmitted to the HTML Client 802 using a standard video streaming protocol. The client 802 then decodes and displays the stream in a preview monitor panel, embedded in the user interface. The client 802 can send commands to the Project Worker 814 to control the position, direction and speed of the stream. For example, the user (via client 802) can quickly skim across the timeline, then play forwards at 100% speed, and then quickly reverse direction at negative 200% speed, all in real-time.

### Supporting Services 816

The client 802 and/or core service 804 may also access/utilize various supporting service 816.

### Exporter 824

Exporter service 824 allows the user to convert a specified timeline to a single audio/video file. The exporter 824 supports various file formats and audio/video codecs and allows exporting at different frame sizes, and frame/audio sample rates.

The exporter 824 writes the file to the object storage 832.

### Databases/Storage 826

Various databases 826 are used to store information from core services 804 and supporting service 816.

### Opset Database 828

The OpSet database 828 is a database that stores the OpSet structures that make up one or more timelines as well as the summary Common Project State.

### Project Metadata Database 830

Project Metadata database 830 is a database that contains information about the project, other than the edits which comprise the timeline. Such information may include: global project settings; media asset information which comprises the project's library (e.g., names of assets, duration, formats, frame/sample rates, and codecs); users participating in the project; and exports which have been shared with users (e.g., via a screenings feature).

### Object Storage 832

The object storage/storage service 832 provides storage for all media assets used by the project. The Project Worker Renderer 814 and Exporter 824 uses the media assets for streaming playback and to create rendered versions of the timeline, written to a media asset—which then is also written to Object Storage 832.

### Logical Flow

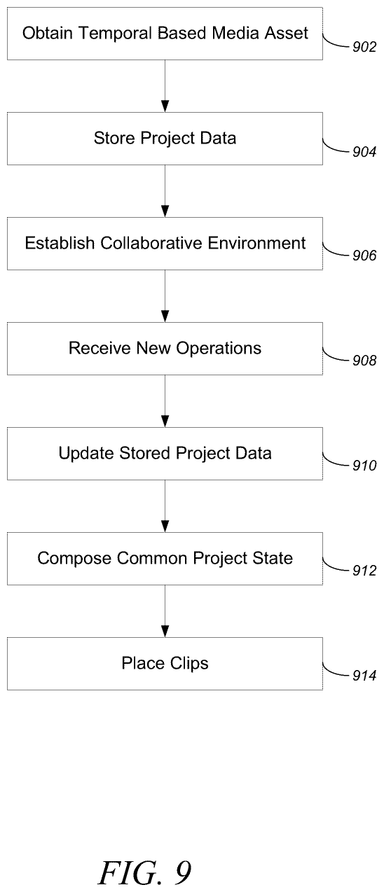

FIG. 9 illustrates the logical flow for conflict-free collaborative temporal based media asset editing in accordance with one or more embodiments of the invention.

At step 902, a temporal based media asset is obtained.

At step 904, project data is stored. The project data includes a set of operations, and each of the operations includes: (1) a mutation of a common project state; and (2) an execution order. The common project state includes two or more clips and one or more timelines. Each of the two or more clips is/defines a temporal region of the temporal based media asset. Each of the one or more timelines is/defines a temporal and mixing order of the one or more clips. Further, the temporal and mixing order is defined referentially wherein a location of each of the two or more clips is defined relatively with respect to at least one of the remaining two or more clips. In one or more embodiments, the execution order is a logical clock timestamp for each operation that defines when in an execution order sequence that operation is executed. Further, in one or more embodiments, the set of operations mutate the common project state in a conflict free manner by requiring that two of the two or more clips cannot exist in a same temporal position in a same mixing order.

In one or more embodiments of the invention, the temporal and mixing order is defined referentially in metadata for each of the two or more clips. In such embodiments, each of the operations may be described by utilizing the referentially defined temporal and mixing order. Further, each of the operations may handle potential conflicts at a time that each operation mutates the common project thereby avoiding the potential conflicts as two users modify one or more of the two or more clips simultaneously.

As described above, the project data is defined by a set of ordered operations that mutate a common project state in a manner (e.g., via enforcement of a rule set) that is guaranteed to be conflict-free. The various rules may include a rule that two clips must not exist in the same temporal position, in the same mixing order. In addition, the data model may prevent any overlap utilizing a rule that requires a clip's position to be specified as related to another, temporally. For example, the Primary Storyline may specify a temporally ordered set (e.g., Clip B follows Clip A without care to how long Clip A is). In such an example, to change the temporal position of Clip A, its new position is described as either following and/or preceding another clip. The data model may never describe a clip as starting at an absolute time. Accordingly, if Clip A's duration is 2 seconds, then implicitly Clip B starts at 2 seconds, directly at the end of Clip A.

In addition, the data model may prevent any overlap by specifying a clip's position as related to another, in mixing priority. For example, Clips may be mixed by attaching them to a Primary Storyline clip in an ordered set. In such embodiments, Clips that exist in a higher position in the set are rendered on top of clips of lower position. To change the mixing order of a Clip, its new position is described as either being rendered above one clip and/or below another clip.

Further to the above, in one or more embodiments, the use of relational references in describing an operation allows the operation to handle any potential conflict at the time it mutates common state, should two users modify clips simultaneously. For example, if two operations mutate the same clip, the operation with the later execution order will win. When specifying a clip's temporal or mixing position as being between two other clips, if the lower clip's position in the set is changed by another user, the clip's position will move in the set after the lower clip's new position. Further, when specifying a clip's temporal or mixing position as being between two other clips, if the lower clip was just removed by another user, the clip can be moved before the higher-ordered clip. Lastly, if both the higher and lower positioned clips are removed by another user, to prevent the moving clip from being lost entirely, it is moved to the end of the set.

At step 906, a collaborative environment is established between two or more participants with respect to the temporal based media asset and the project data.

Steps 908-914 are performed in/within the collaborative environment.

At step 908, each of the two or more participants receives one or more new operations from other participants of the two or more participants in real time as the new operations are input.

At step 910, the stored project data is updated with the one or more new operations.

At step 912, the common project state is composed. The composing processes each of the operations in the updated stored project data in the execution order.

At step 914, two or more clips of the two or more clips are placed based on the temporal and mixing order such that the two or more clips of the two or more clips cannot be placed in a same location on a single timeline of the one or more timelines.

In one or more embodiments, within the collaborative environment steps 908-914 may also include the generation of a layout model. More specifically, in one or more embodiments, the common project state is converted to an absolute layout model by converting each of the two or more clips by laying them out into the one or more timelines to generate a layout. The layout is then utilized as a visual model in a graphical user interface that each of the two or more participants interacts with. Further, the layout may be utilized to derive a rendering order for playback and export of the two or more clips.

In an example of the conversion from its conflict-free relational model to an absolute layout model, the common project state may be converted to a raw data model based on ordered sets: B comes after A, C is over B. Thereafter, there is an engine that converts these clips, laying them out into a timeline in a predefined order (going left to right, bottom to top). In particular, the layout for the Primary Storyline places one clip directly after its predecessor, and attached clips are layered on top of its Primary, given an offset. If there is an attached clip in the same temporal position in that layer, the attached clip will be promoted to a higher layer.

Further, in additional embodiments, steps 908-914 may also include representing live interactions of the two or more participants to all other participants in real-time. Such a representation may be performed by defining additional data in the project data that represents a spatial position of a first clip of the two or more clips as it is being dragged in a first timeline of the one or more timelines, wherein the additional data describes a current position of the first clip and a relative position from a start of the live interactions. Thereafter, the additional data is utilized to visually distinguish (e.g., via a dashed line, highlighting, bold, different color, etc.) an actual valid location of the first clip in the first timeline. Further, the additional data is utilized to visually distinguish in-flight movement of the first clip from remaining clips of the two or more clips (e.g., to visually distinguish a user's actions and elements the users are working on from the rest of the clips/assets/elements). Such capabilities are used to inform all users of any activity being performed by another user. Further, as clips are interacted with, they still go through the same layout process described above, slotted into the timeline following the standard layout left to right, bottom to top rules.

Steps 908-914 may also provide the capability to maintain the user's viewport. In this regard, a participant's viewport is defined and includes/consists of current elements within a viewing window. Focus of the participant's viewport may be maintained on the current elements as upstream changes are made to the one or more timelines by other participants. For example, if a user is looking at material at the ten second mark, but another user deletes two (2) seconds of material earlier in the timeline, even though the entire timeline will shift left by two (2) seconds, the viewport shifts with it. Accordingly, a user's viewport of the timeline is maintained even as upstream changes are made to the timeline that would normally shift the contents of their view.

Steps 908-914 may also provide the ability to revert to a project state at any granular point in its history. In particular, the project data (e.g., the operations and the execution order) can be stored in a non-destructive form. Thereafter, a selection of a single operation of the set of operations is received. Such a selected single operation is in a history of the set of operations and is prior to a most recent operation. In response to the selection, the common project state is displayed from an execution time of the single operation thereby providing a granular view of the project data. Thereafter, when the single operation is edited in the granular view, the edits ripple through the project data (i.e., the rest of the project). Such a sequence of steps provides enables collaborating users to go back to any single operation within the execution order to view the project state at that time. Further, operations may be spliced in/out at that point in the timeline.

### Hardware Environment

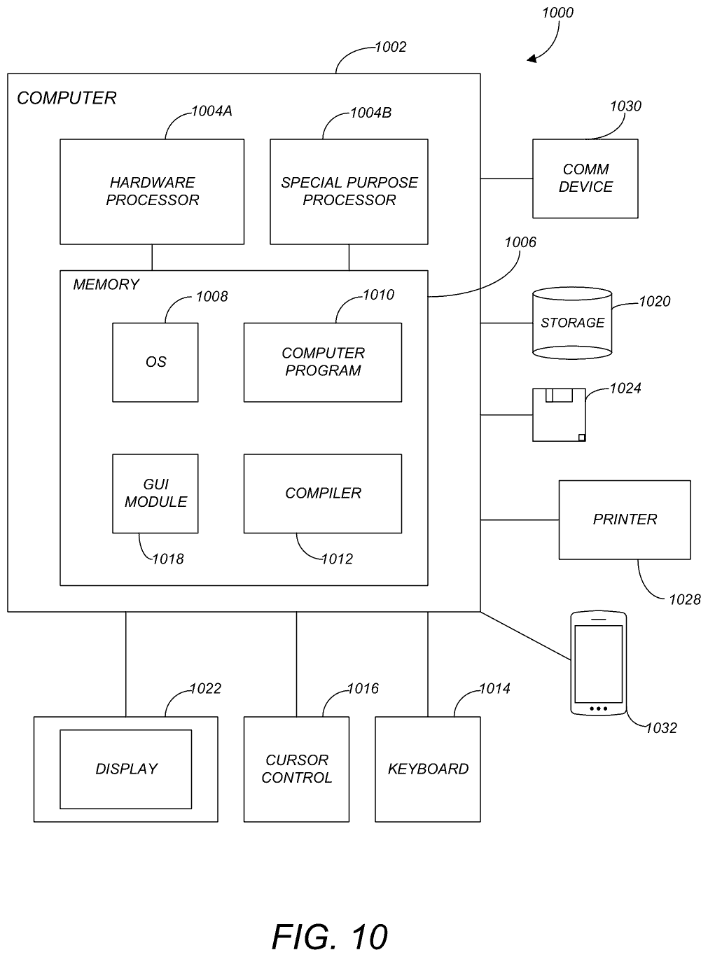

FIG. 10 is an exemplary hardware and software environment 1000 (referred to as a computer-implemented system and/or computer-implemented method) used to implement one or more embodiments of the invention. The hardware and software environment includes a computer 1002 and may include peripherals. Computer 1002 may be a user/client computer, server computer, or may be a database computer. The computer 1002 comprises a hardware processor 1004A and/or a special purpose hardware processor 1004B (hereinafter alternatively collectively referred to as processor 1004) and a memory 1006, such as random access memory (RAM). The computer 1002 may be coupled to, and/or integrated with, other devices, including input/output (I/O) devices such as a keyboard 1014, a cursor control device 1016 (e.g., a mouse, a pointing device, pen and tablet, touch screen, multi-touch device, etc.) and a printer 1028. In one or more embodiments, computer 1002 may be coupled to, or may comprise, a portable or media viewing/listening device 1032 (e.g., an MP3 player, IPOD, NOOK, portable digital video player, cellular device, personal digital assistant, etc.). In yet another embodiment, the computer 1002 may comprise a multi-touch device, mobile phone, gaming system, internet enabled television, television set top box, or other internet enabled device executing on various platforms and operating systems.

In one embodiment, the computer 1002 operates by the hardware processor 1004A performing instructions defined by the computer program 1010 (e.g., a computer-aided design [CAD] application) under control of an operating system 1008. The computer program 1010 and/or the operating system 1008 may be stored in the memory 1006 and may interface with the user and/or other devices to accept input and commands and, based on such input and commands and the instructions defined by the computer program 1010 and operating system 1008, to provide output and results.

Output/results may be presented on the display 1022 or provided to another device for presentation or further processing or action. In one embodiment, the display 1022 comprises a liquid crystal display (LCD) having a plurality of separately addressable liquid crystals. Alternatively, the display 1022 may comprise a light emitting diode (LED) display having clusters of red, green and blue diodes driven together to form full-color pixels. Each liquid crystal or pixel of the display 1022 changes to an opaque or translucent state to form a part of the image on the display in response to the data or information generated by the processor 1004 from the application of the instructions of the computer program 1010 and/or operating system 1008 to the input and commands. The image may be provided through a graphical user interface (GUI) module 1018. Although the GUI module 1018 is depicted as a separate module, the instructions performing the GUI functions can be resident or distributed in the operating system 1008, the computer program 1010, or implemented with special purpose memory and processors.

In one or more embodiments, the display 1022 is integrated with/into the computer 1002 and comprises a multi-touch device having a touch sensing surface (e.g., track pod, touch screen, smartwatch, smartglasses, smartphones, laptop or non-laptop personal mobile computing devices) with the ability to recognize the presence of two or more points of contact with the surface. Examples of multi-touch devices include mobile devices (e.g., IPHONE, ANDROID devices, WINDOWS phones, GOOGLE PIXEL devices, NEXUS S, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations/actions performed by the computer 1002 according to the computer program 1010 instructions may be implemented in a special purpose processor 1004B. In this embodiment, some or all of the computer program 1010 instructions may be implemented via firmware instructions stored in a read only memory (ROM), a programmable read only memory (PROM) or flash memory within the special purpose processor 1004B or in memory 1006. The special purpose processor 1004B may also be hardwired through circuit design to perform some or all of the operations/actions to implement the present invention. Further, the special purpose processor 1004B may be a hybrid processor, which includes dedicated circuitry for performing a subset of functions, and other circuits for performing more general functions such as responding to computer program 1010 instructions. In one embodiment, the special purpose processor 1004B is an application specific integrated circuit (ASIC).

The computer 1002 may also implement a compiler 1012 that allows an application or computer program 1010 written in a programming language such as C, C++, Assembly, SQL, PYTHON, PROLOG, MATLAB, RUBY, RAILS, HASKELL, or other language to be translated into processor 1004 readable code. Alternatively, the compiler 1012 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1010 accesses and manipulates data accepted from I/O devices and stored in the memory 1006 of the computer 1002 using the relationships and logic that were generated using the compiler 1012.

The computer 1002 also optionally comprises an external communication device such as a modem, satellite link, Ethernet card, or other device for accepting input from, and providing output to, other computers 1002.

In one embodiment, instructions implementing the operating system 1008, the computer program 1010, and the compiler 1012 are tangibly embodied in a non-transitory computer-readable medium, e.g., data storage device 1020, which could include one or more fixed or removable data storage devices, such as a zip drive, floppy disc drive 1024, hard drive, CD-ROM drive, tape drive, etc. Further, the operating system 1008 and the computer program 1010 are comprised of computer program 1010 instructions which, when accessed, read and executed by the computer 1002, cause the computer 1002 to perform the steps necessary to implement and/or use the present invention or to load the program of instructions into a memory 1006, thus creating a special purpose data structure causing the computer 1002 to operate as a specially programmed computer executing the method steps described herein. Computer program 1010 and/or operating instructions may also be tangibly embodied in memory 1006 and/or data communications devices 1030, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1002.

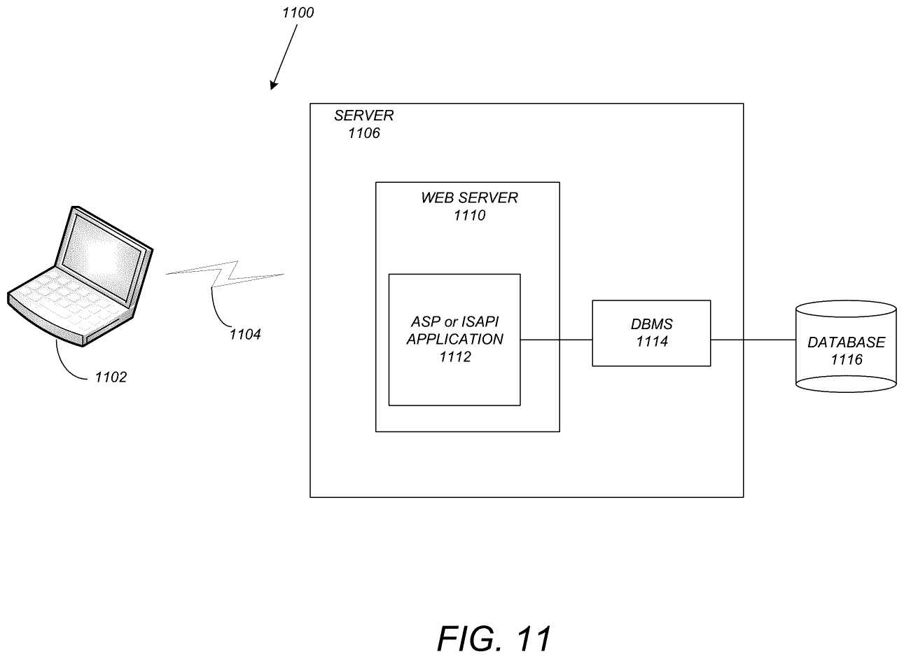

FIG. 11 schematically illustrates a typical distributed/cloud-based computer system 1100 using a network 1104 to connect client computers 1102 to server computers 1106. A typical combination of resources may include a network 1104 comprising the Internet, LANs (local area networks), WANs (wide area networks), SNA (systems network architecture) networks, or the like, clients 1102 that are personal computers or workstations (as set forth in FIG. 10), and servers 1106 that are personal computers, workstations, minicomputers, or mainframes (as set forth in FIG. 10). However, it may be noted that different networks such as a cellular network (e.g., GSM [global system for mobile communications] or otherwise), a satellite based network, or any other type of network may be used to connect clients 1102 and servers 1106 in accordance with embodiments of the invention.

A network 1104 such as the Internet connects clients 1102 to server computers 1106. Network 1104 may utilize ethernet, coaxial cable, wireless communications, radio frequency (RF), etc. to connect and provide the communication between clients 1102 and servers 1106. Further, in a cloud-based computing system, resources (e.g., storage, processors, applications, memory, infrastructure, etc.) in clients 1102 and server computers 1106 may be shared by clients 1102, server computers 1106, and users across one or more networks. Resources may be shared by multiple users and can be dynamically reallocated per demand. In this regard, cloud computing may be referred to as a model for enabling access to a shared pool of configurable computing resources.

Clients 1102 may execute a client application or web browser and communicate with server computers 1106 executing web servers 1110. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1102 may be downloaded from server computer 1106 to client computers 1102 and installed as a plug-in or ACTIVEX control of a web browser. Accordingly, clients 1102 may utilize ACTIVEX components/component object model (COM) or distributed COM (DCOM) components to provide a user interface on a display of client 1102. The web server 1110 is typically a program such as MICROSOFT'S INTERNET INFORMATION SERVER.

Web server 1110 may host an Active Server Page (ASP) or Internet Server Application Programming Interface (ISAPI) application 1112, which may be executing scripts. The scripts invoke objects that execute business logic (referred to as business objects). The business objects then manipulate data in database 1116 through a database management system (DBMS) 1114. Alternatively, database 1116 may be part of, or connected directly to, client 1102 instead of communicating/obtaining the information from database 1116 across network 1104. When a developer encapsulates the business functionality into objects, the system may be referred to as a component object model (COM) system. Accordingly, the scripts executing on web server 1110 (and/or application 1112) invoke COM objects that implement the business logic. Further, server 1106 may utilize MICROSOFT'S TRANSACTION SERVER (MTS) to access required data stored in database 1116 via an interface such as ADO (Active Data Objects), OLE DB (Object Linking and Embedding DataBase), or ODBC (Open DataBase Connectivity).

Generally, these components 1100-1116 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1102 and 1106 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1102 and 1106. Embodiments of the invention are implemented as a software/CAD application on a client 1102 or server computer 1106. Further, as described above, the client 1102 or server computer 1106 may comprise a thin client device or a portable device that has a multi-touch-based display.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for conflict-free collaborative temporal based media asset editing comprising:
(a) obtaining a temporal based media asset;
(b) storing project data, wherein:
(i) the project data comprises a set of operations;
(ii) each of the operations comprises:
(1) a mutation of a common project state; and
(2) an execution order;
(iii) the common project state comprises two or more clips and one or more timelines;
(iv) each of the two or more clips comprises a temporal region of the temporal based media asset;
(v) each of the one or more timelines comprises a temporal and mixing order of the one or more clips;
(vi) the temporal and mixing order is defined referentially wherein a location of each of the two or more clips is defined relatively with respect to at least one of the remaining two or more clips;
(c) establishing a collaborative environment between two or more participants with respect to the temporal based media asset and the project data; and
(d) in the collaborative environment:
(i) each of the two or more participants receiving one or more new operations from other participants of the two or more participants in real time as the new operations are input;
(ii) updating the stored project data with the one or more new operations;
(iii) composing the common project state, wherein the composing processes each of the operations in the updated stored project data in the execution order; and
(iv) placing two or more clips of the two or more clips based on the temporal and mixing order such that the two or more clips of the two or more clips cannot be placed in a same location on a single timeline of the one or more timelines.

2. The computer-implemented method of claim 1, wherein the execution order comprises a logical clock timestamp for each operation that defines when in an execution order sequence that operation is executed.

3. The computer-implemented method of claim 1, wherein the set of operations mutate the common project state in a conflict free manner by:
requiring that two of the two or more clips cannot exist in a same temporal position in a same mixing order.

4. The computer-implemented method of claim 1, wherein:
the temporal and mixing order is defined referentially in metadata for each of the two or more clips.

5. The computer-implemented method of claim 4, wherein:
the method further comprises describing each of the operations utilizing the referentially defined temporal and mixing order; and
each of the operations handles potential conflicts at a time that each operation mutates the common project thereby avoiding the potential conflicts as two users modify one or more of the two or more clips simultaneously.

6. The computer-implemented method of claim 1, further comprising:
converting the common project state to an absolute layout model by converting each of the two or more clips by laying them out into the one or more timelines to generate a layout;
utilizing the layout as a visual model in a graphical user interface that each of the two or more participants interacts with; and
utilizing the layout to derive a rendering order for playback and export of the two or more clips.

7. The computer-implemented method of claim 6, further comprising representing live interactions of the two or more participants to all other participants in real-time by:
(a) defining additional data in the project data that represents a spatial position of a first clip of the two or more clips as it is being dragged in a first timeline of the one or more timelines, wherein the additional data describes a current position of the first clip and a relative position from a start of the live interactions;
(b) utilizing the additional data to visually distinguish an actual valid location of the first clip in the first timeline; and
(c) utilizing the additional data to visually distinguish in-flight movement of the first clip from remaining clips of the two or more clips.

8. The computer-implemented method of claim 6, further comprising:
defining a participant's viewport that comprises current elements within a viewing window; and
maintaining focus of the participant's viewport on the current elements as upstream changes are made to the one or more timelines by other participants.

9. The computer-implemented method of claim 1, further comprising:
storing the project data in a non-destructive form;
receiving a selection of a single operation of the set of operations, wherein the single operation is in a history of the set of operations and is prior to a most recent operation; and
in response to the selection, displaying the common project state from an execution time of the single operation thereby providing a granular view of the project data.

10. The computer-implemented method of claim 9, further comprising:
editing the single operation in the granular view; and
based on the edits, rippling the edits through the project data.

11. A computer-implemented system for conflict-free collaborative temporal based media asset editing comprising:
(a) a computer having a memory;
(b) a processor executing on the computer;
(c) the memory storing a set of instructions, wherein the set of instructions, when executed by the processor cause the processor to perform actions comprising:
(a) obtaining a temporal based media asset;
(b) storing project data, wherein:
(i) the project data comprises a set of operations;
(ii) each of the operations comprises:
(1) a mutation of a common project state; and
(2) an execution order;
(iii) the common project state comprises two or more clips and one or more timelines;
(iv) each of the one or more clips comprises a temporal region of the temporal based media asset;
(v) each of the one or more timelines comprises a temporal and mixing order of the one or more clips;
(vi) the temporal and mixing order is defined referentially wherein a location of each of the two or more clips is defined relatively with respect to at least one of the remaining two or more clips;
(c) establishing a collaborative environment between two or more participants with respect to the temporal based media asset and the project data; and
(d) in the collaborative environment:
(i) each of the two or more participants receives one or more new operations from other participants of the two or more participants in real time as the new operations are input;
(ii) updating the stored project data with the one or more new operations;
(iii) composing the common project state, wherein the composing processes each of the operations in the updated stored project data in the execution order; and
(iv) two or more clips of the two or more clips are placed based on the temporal and mixing order such that the two or more clips of the two or more clips cannot be placed in a same location on a single timeline of the one or more timelines.

12. The computer-implemented system of claim 11, wherein the execution order comprises a logical clock timestamp for each operation that defines when in an execution order sequence that operation is executed.

13. The computer-implemented system of claim 11, wherein the set of operations mutate the common project state in a conflict free manner by:
requiring that two of the two or more clips cannot exist in a same temporal position in a same mixing order.

14. The computer-implemented system of claim 11, wherein:
the temporal and mixing order is defined referentially in metadata for each of the two or more clips.

15. The computer-implemented system of claim 14, wherein:
the actions further comprise describing each of the operations utilizing the referentially defined temporal and mixing order; and
each of the operations handles potential conflicts at a time that each operation mutates the common project thereby avoiding the potential conflicts as two users modify one or more of the two or more clips simultaneously.

16. The computer-implemented system of claim 11, wherein the actions further comprise:
converting the common project state to an absolute layout model by converting each of the two or more clips by laying them out into the one or more timelines to generate a layout;
utilizing the layout as a visual model in a graphical user interface that each of the two or more participants interacts with; and
utilizing the layout to derive a rendering order for playback and export of the two or more clips.

17. The computer-implemented system of claim 16, wherein the actions further comprise representing live interactions of the two or more participants to all other participants in real-time by:
(a) defining additional data in the project data that represents a spatial position of a first clip of the two or more clips as it is being dragged in a first timeline of the one or more timelines, wherein the additional data describes a current position of the first clip and a relative position from a start of the live interactions;
(b) utilizing the additional data to visually distinguish an actual valid location of the first clip in the first timeline; and
(c) utilizing the additional data to visually distinguish in-flight movement of the first clip from remaining clips of the two or more clips.

18. The computer-implemented system of claim 16, wherein the actions further comprise:
defining a participant's viewport that comprises current elements within a viewing window; and
maintaining focus of the participant's viewport on the current elements as upstream changes are made to the one or more timelines by other participants.

19. The computer-implemented system of claim 11, wherein the actions further comprise:
storing the project data in a non-destructive form;
receiving a selection of a single operation of the set of operations, wherein the single operation is in a history of the set of operations and is prior to a most recent operation; and
in response to the selection, displaying the common project state from an execution time of the single operation thereby providing a granular view of the project data.

20. The computer-implemented system of claim 19, wherein the actions further comprise:
editing the single operation in the granular view; and
based on the edits, rippling the edits through the project data.
